(19) United States
(12) Patent Application Publication
(10) Pub. No.: US 2005/0105284 A1
(43) Pub. Date: May 19, 2005

(54) Backlight device and display apparatus

(75) Inventor: Shinichi Ishizuka, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/960,283

(22) Filed: Oct. 8, 2004

(30) Foreign Application Priority Data
Oct. 9, 2003 (JP) 2003-350424

(51) Int. Cl. F21V 9/16

(52) U.S. Cl. 362/84; 362/552

(57) ABSTRACT

A backlight device comprises a surface luminescent body and a light control section. The surface luminescent body includes a surface luminescent layer and first and second electrode layers sandwiching the surface luminescent layer. The light control section supplies a drive signal to the first and second electrode layers to cause the surface luminescent body to emit light. At least one of the first and second electrode layers is divided into a plurality of electrode pieces. The light control section supplies the drive signal individually to the plurality of electrode pieces.

### BACKGROUND OF THE INVENTION

1. Field of the Invention

The present invention relates to a display apparatus such as a liquid-crystal display, and to a backlight to be mounted on the same.

2. Description of the Related Art

As shown in FIG. 1, a transmissive or semi-transmissive liquid-crystal display generally incorporates therein a backlight 3 for illuminating a backside of a liquid-crystal panel 1 filled with liquid-crystal molecules. The transmissive liquid-crystal display allows a viewer to observe the light emitted from the backlight 3 and transmitted through the liquid-crystal panel 1. The semi-transmissive liquid-crystal display allows a viewer to observe the emitted light from the backlight 3 in the dark place, and to observe external light such as natural light reflected on the liquid-crystal panel 1 without the use of the backlight 3 in the light. There are proposals of cold cathode ray tubes, LEDs (light-emitting diodes), inorganic EL (electroluminescence), organic EL and so on, as backlights for liquid-crystal displays.

The conventional transmissive or semi-transmissive liquid crystal display has a problem in that, in the transmission mode using the backlight 3, power is consumed because the backlight 3 emits light at the entire surface regardless of contents of display. For example, referring to FIG. 1, the entire surface of backlight 3 emits light at all times when the liquid-crystal display displays the characters “AA” in black while displaying black images in both the upper region 2a and the lower region 2d. The light from the backlight 3 is blocked off by the liquid crystal layer at the region 2b, 2c corresponding to these two characters and at the upper region 2a and lower region 2d.

In order to avoid the entire surface of a backlight mounted on a cellular telephone from emitting light at all times, Japanese Patent Kokai No. 2002-101195 discloses such a structure that the backlight is divided into a plurality of parts which are individually controlled. However, the structure described in the Kokai publication requires for the cellular telephone to mount thereon a plurality of backlights structured independent, resulting in increased circuit scale. This makes it difficult to reduce the cost of manufacture.

### SUMMARY OF THE INVENTION

In view of the foregoing, it is an object of the present invention to provide a backlight device capable of realizing low power consumption, and a display apparatus having the same.

According to a first aspect of the invention, there is provided a backlight device for illuminating a backside of a display panel having a plurality of display cells arranged in a matrix form, each of the display cells having a light transmissivity varying in response to a drive voltage applied. The backlight device comprises: a surface luminescent body positioned at a backside of the display panel, and including a surface luminescent layer and first and second electrode layers sandwiching the surface luminescent layer; and a light control section for supplying a drive signal to the first and second electrode layers to cause the surface luminescent body to emit light. At least one of the first and second electrode layers is divided into a plurality of electrode pieces, and the light control section supplies the drive signal individually to the plurality of electrode pieces.

According to a second aspect of the invention, a display apparatus is provided. The display apparatus comprises: a display panel having a plurality of display cells arranged in a matrix form, each of the display cells having a light transmissivity varying in response to a drive voltage applied; a peripheral drive circuit for generating the drive voltage from an image signal supplied to supply the drive voltage to the display cell; and a backlight device for illuminating a backside of the display panel. The backlight device further includes: a surface luminescent body positioned at a backside of the display panel, and having a surface luminescent layer and first and second electrode layers sandwiching the surface luminescent layer; and a light control section for supplying a drive signal to the first and second electrode layers to cause the surface luminescent body to emit light. At least one of the first and second electrode layers is divided into a plurality of electrode pieces, and the light control section supplies the drive signal individually to the plurality of electrode pieces.

Further features of the invention, its nature and various advantages will be more apparent from the accompanying drawings and the following detailed description of the preferred embodiments.

### BRIEF DESCRIPTION OF THE DRAWINGS

FIG. 1 is a diagram illustrating the relationship between a liquid-crystal display and a backlight;

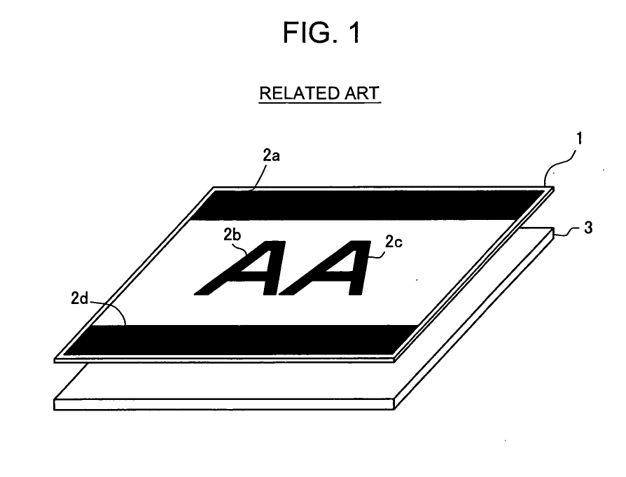

FIG. 2 is a block diagram schematically illustrating a configuration of a liquid-crystal display apparatus which is an embodiment of the present invention;

FIG. 3 is a diagram schematically illustrating a sectional structure of an EL panel;

FIG. 4 is a diagram schematically illustrating a configuration of a backlight unit which is an embodiment of the present invention;

FIG. 5 is a diagram schematically illustrating a boundary between two electrode pieces;

FIG. 6 is a diagram schematically illustrating a configuration of a backlight unit which is a modification of the embodiment shown in FIG. 4;

FIG. 7 is a diagram schematically illustrating a configuration of a backlight unit which is another modification of the embodiment shown in FIG. 4; and

FIG. 8 is a diagram schematically illustrating a configuration of a backlight unit which is a further embodiment of the present invention.

### DETAILED DESCRIPTION OF THE INVENTION

Various embodiments according to the present invention will be described.

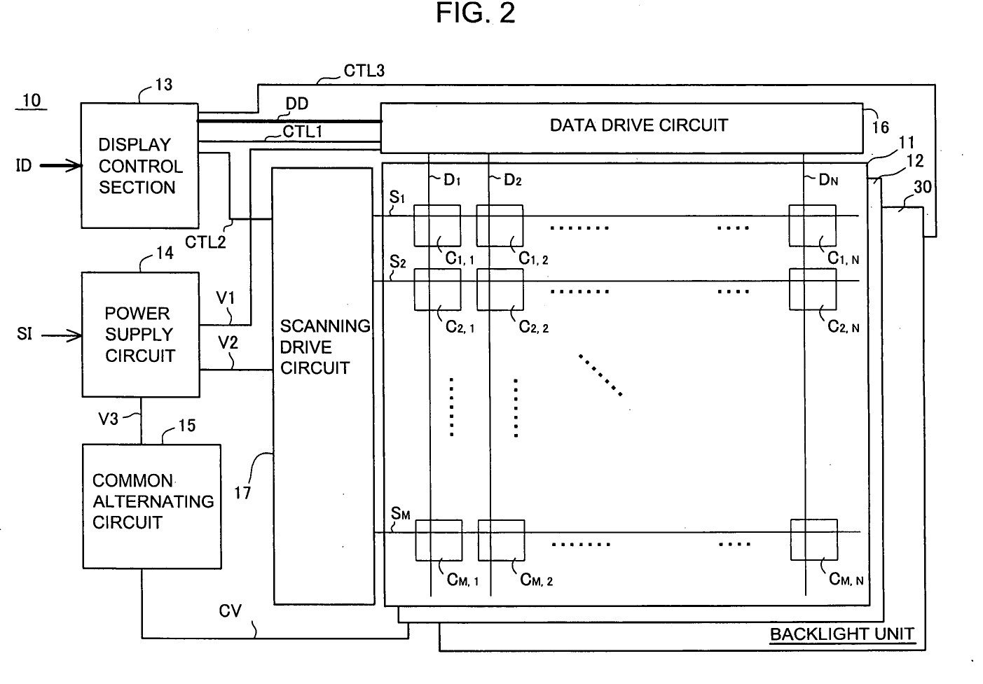

FIG. 2 is a block diagram schematically illustrating a structure of a liquid crystal display apparatus 10 in an active-matrix driving scheme according to the present embodiment. The liquid-crystal display apparatus 10 has a display panel 11 and a common electrode 12, further having a peripheral drive circuit including a display control section 13, a power supply circuit 14, a common alternating circuit 15, a data drive circuit 16 and a scanning drive circuit 17. The liquid-crystal display apparatus 10 further includes a backlight unit 30 for illuminating the display panel 11 at the backside thereof.

On a substrate structuring the display panel 11, there are formed data electrodes D₁, D₂, . . . , D_{N} in the number of N (N is an integer equal to or greater than 2) connected to the data drive circuit 16 and scanning electrodes S₁, S₂, . . . , S_{M} in the number of M (M is an integer equal to or greater than 2) connected to the scanning drive circuit 17, the data electrodes and scanning electrodes intersecting with each other and being spaced-apart from each other. At the intersections of the data electrodes D₁-D_{N} and the scanning electrodes S₁-S_{M}, display cells C_{1,1}, C_{1,2}, . . . C_{1,N}, . . . C_{M,N} are formed in the number of N×M respectively having TFT (thin film transistor) elements. The display cells C_{1,1}-C_{M,N} each include ferroelectric liquid-crystal molecules filled between the two glass substrates.

Incidentally, each of the display cells C_{1,1}-C_{M,N} may configure one pixel. Otherwise, in order to implement color display or area-ratio gray scale, one pixel may be configured by a plurality of ones of the display cells C_{1,1}-C_{M,N}.

An operation of the liquid-crystal display apparatus 10 is outlined in the following. To the display control section 13, inputted is an input signal ID including a synchronizing signal, a clock signal and an image signal. The display control section 13 temporarily stores an image signal and converts it into a data signal DD in a predetermined format, then supplying the converted signal to the data drive circuit 16. The display control section 13 furthermore generates control signals CTL1, CTL2 and CTL3 from the synchronizing signal and clock signal and supplies them respectively to the data drive circuit 16, the scanning drive circuit 17 and the backlight unit 30. Meanwhile, the power supply circuit 14 generates drive voltages V1, V2 and V3 on the basis of a power supply voltage SI supplied from the external and supplies those voltages respectively to the data drive circuit 16, the scanning driving circuit 17 and the common alternating circuit 15. The common alternating circuit 15 generates a common voltage from the drive voltage V3 supplied from the power supply circuit 14 and supplies the common voltage to the common electrode 12.

The scanning drive circuit 17 applies pulse voltages sequentially to the scanning electrodes S₁-S_{N}, on the basis of the control signal CTL2 inputted from the display control section 13, thereby causing the switches of the TFT elements connected to the scanning electrodes S1-S_{N} to sequentially turn on line by line. The data drive circuit 16 generates output voltages on the basis of the drive voltage V1, control signal CTL1 and data signal DD and supplies the output voltages to the data electrodes D₁-D_{N}. The output voltage is thereby applied to the capacitor of a display cell through the TFT element being in an on state. Electric charge is stored in the capacitor, forming an applied voltage to a liquid crystal layer in the display cell. The liquid-crystal molecules in the liquid crystal layer are in a state of orientation allowed to vary depending upon the applied voltage, hence forming a light transmissivity of the display cell C_{1,1}-C_{M,N}.

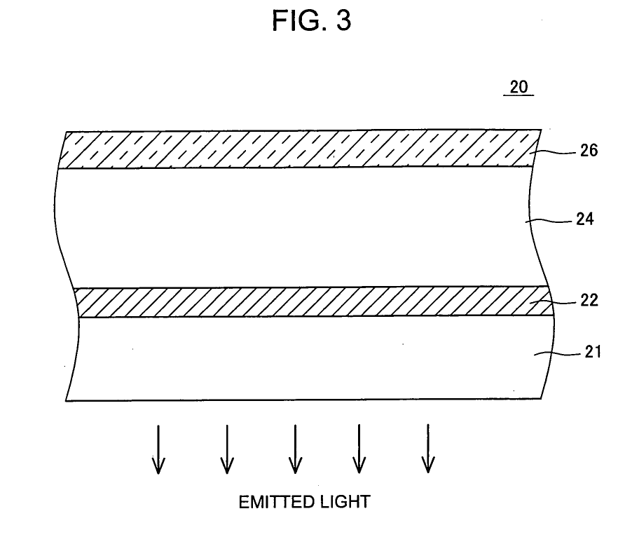

Next, the structure of the backlight unit (backlight device) 30 will be described. This backlight unit 30 has an EL panel (surface luminescent body) 20 having a sectional structure shown in FIG. 3. The EL panel 20 is structured by oppositely arranging a metal electrode layer (cathode) 26 and a transparent electrode layer (anode) 22 of ITO (indium thin oxide) formed on a substrate 21, and providing a luminescent layer 24 between the both electrode layers 22, 26. The luminescent layer 24 includes an organic EL material. In response to a drive signal supplied, recombination occurs between electrons injected at the cathode 26 and holes injected through the anode 22 in the luminescent layer 24, thereby forming photons. The luminescent layer 24 can emit light from a planar surface by a voltage difference of equal to or greater than a luminescent threshold voltage to between the cathode 26 and the anode 22, or injection of current through the anode 22. Note that, the luminescent layer 24 includes an organic EL material in the present embodiment, no limitation thereto intended. The luminescent layer 24 may include an inorganic EL material or may be an LED.

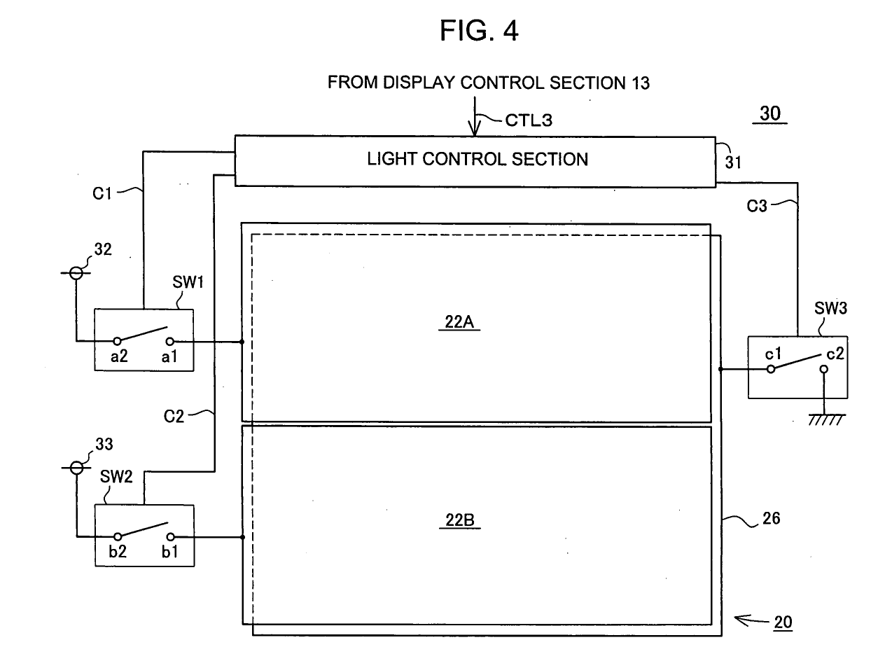

FIG. 4 is a diagram schematically illustrating a structure of the backlight unit 30 which is an embodiment of the present invention. FIG. 4 illustrates only an anode 22 and cathode 26 of the EL panel 20, for the convenience of explanation. The backlight unit 30 has an EL panel 20 including an anode 22 (22A, 22B) and a cathode 26, a light control section 31 and switch circuits SW1, SW2, SW3. The anode 22 only is divided into a first electrode piece 22A and a second electrode piece 22B. The first electrode piece 22A has an area corresponding to the upper half pixel region of the display panel 11 (see FIG. 2) while the second electrode piece 22B has an area corresponding to the lower half pixel region of the display panel 11 (see FIG. 2). The luminescent layer 24 (FIG. 3) formed between the anode 22 (22A, 22B) and the cathode 26 is continuous in distribution without being divided like the anode 22.

The light control section 31 can supply drive signals individually to the first electrode piece 22A and the second electrode piece 22B. Specifically, the first electrode piece 22A is connected to a terminal a1 of the switch circuit SW1 while the second electrode piece 22B is connected to a terminal b1 of the switch circuit SW2. The other terminal a2 of the switch circuit SW1 is connected to a drive power supply 32 so that the switch circuit SW1 can electrically connect or disconnect between the first electrode piece 22A and the drive power supply 32 according to a switch control signal C1 supplied from the luminance control section 31. Meanwhile, the terminal b2 of the switch circuit SW2 is connected to a drive power supply 33 so that the switch circuit SW2 can electrically connect or disconnect between the second electrode piece 22B and the drive power supply 33 according to a switch control signal C2 supplied from the luminance control section 31. Incidentally, the cathode 26 is connected to a terminal c1 of the switch circuit SW3. The other terminal c2 of the switch circuit SW3 is grounded so that the switch circuit SW3 can ground or insulate the cathode 26 according to a switch control signal C3 supplied from the luminance control section 31.

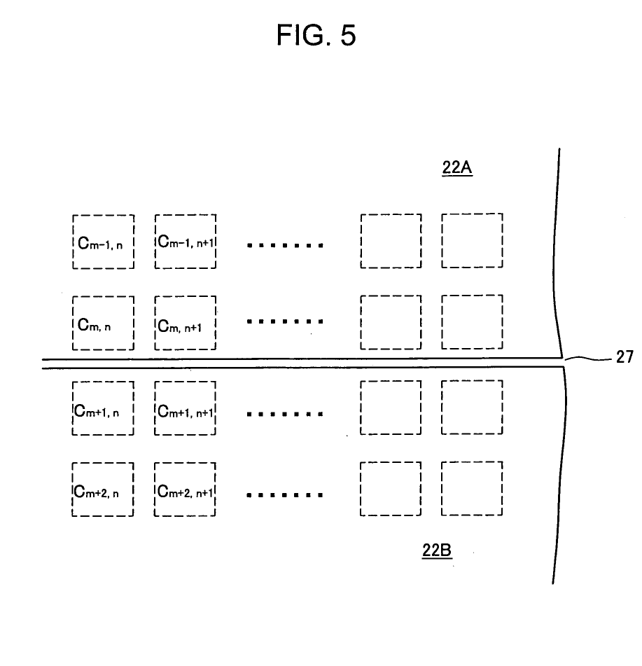

The backlight unit 30, because having two luminescent regions as divisions of the EL panel 20, is to form a boundary line (discontinuation line) at between luminescent regions. In order to avoid the situation such a boundary line from overlapping with the display cell to thereby lower image quality, as shown in FIG. 5, a boundary line 27 extending between the first electrode piece 22A and the second electrode piece 22B preferably corresponds to a boundary between the display cells C_{m-1,n}, C_{m-1,n+1}.

In order to positively avoid against forming a boundary line 27, the first electrode piece 22A and the second electrode piece 22B may be overlapped with a gap at their mutual opposite ends. Furthermore, in order to relieve the affection of the boundary line 27, a light dispersion layer may be interposed between the EL panel 20 and the display panel 11.

In the backlight unit 30 structured as described above, the light control section 31 supplies a drive signal only to the electrode piece corresponding to the region other than the display region in black of the display panel 11, on the basis of a control signal CTL3 inputted from the display control section 13. For example, when putting on the display panel 11 at the lower half of the pixel region, the light control section 31 closes the switch of the switch circuit SW3, opens the switch of the switch circuit SW1 and closes the switch of the switch circuit SW2. This provides a drive signal only to the second electrode piece 22B corresponding to the lower half pixel region, to put on the EL panel 20 at only the lower region thereof. When putting on the display panel 11 at the upper half pixel region, the switch of the switch circuit SW3 is closed, the switch of the switch circuit SW1 is closed and the switch of the switch circuit SW2 is opened. This provides a drive signal only to the first electrode piece 22A corresponding to the upper half pixel region, to put on the EL panel 20 at only the upper region thereof. When the entire pixel region of the display panel 11 displays black, the luminescent control section 31 opens the switches of the switch circuits SW1, SW2, thereby putting off the EL panel 20 in the entire surface without giving a drive signal to the first and second electrode piece 22A, 22B.

Incidentally, a method of providing drive signals to the first electrode 22A, second electrode 22B and cathode 26 is not limited to the method shown in FIG. 4. As another method, when making a black display in any display region (pixel region) of the upper half and the lower half of the display panel 11 for example, instead of putting off the relevant display region by opening the switch of the switch circuit connected to the electrode piece corresponding to the relevant display region so as not to provide a drive signal to the electrode piece, a lower voltage than a luminescence threshold voltage of the EL device may be applied to the electrode piece. When making a black display in the entire display region of the display panel 1, the voltage to be applied to the cathode 26 may be set at a level higher than a difference (V_{D}−V_{LS}) between a drive signal voltage (V_{D}) to be applied to the anode 22 and a luminance threshold voltage (V_{LS}), instead of opening the switch of the switch circuit SW3. Furthermore, another configuration can be designed to omit the switch circuit SW3 and connect the cathode 26 to the ground. Similar effect is obtainable by dividing the cathode 26 instead of dividing the anode 22.

As described above, in the backlight unit 30 of the above embodiment, one of the cathode 26 and the anode 22 is divided into two electrode pieces 22A, 22B so that the light control section 31 can individually control the drive signals to be supplied to the electrodes 22A, 22B. This can put off the corresponding region of the EL panel 20 to a display region in black of the display panel 11 and put on the corresponding region of the EL panel 20 to a light display region of the display panel 11. Accordingly, the backlight unit 30 can be greatly reduced in consumption power. In addition, contrast ratio is improved because the display region in black of the display panel 11 is not illuminated by the backlight unit 30. Furthermore, because of no necessity to incorporate in the display apparatus a plurality of backlights structured independent, consumption power reduction can be achieved while suppressing an increase in production costs.

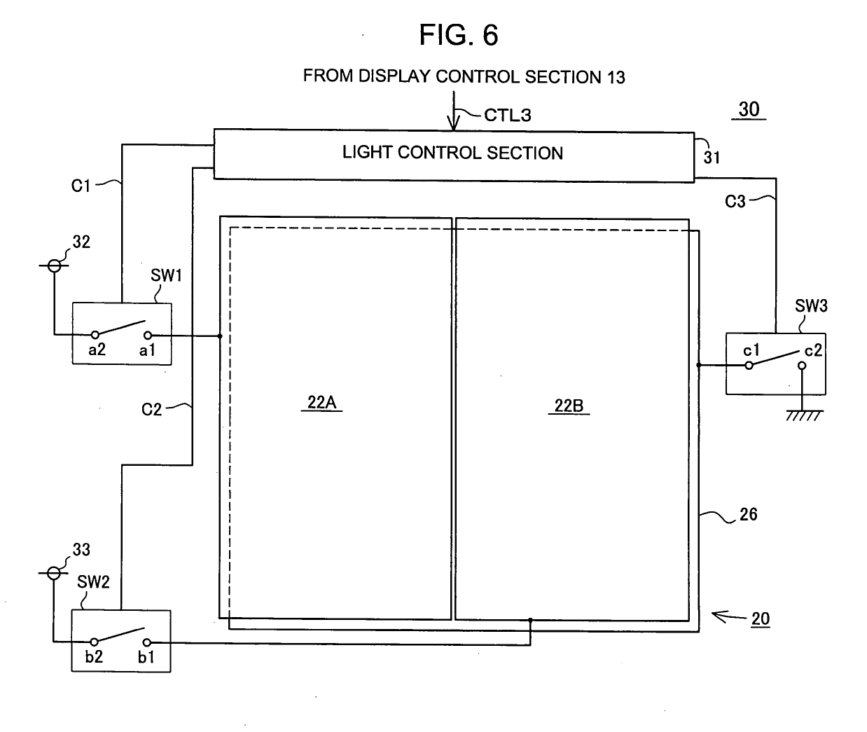

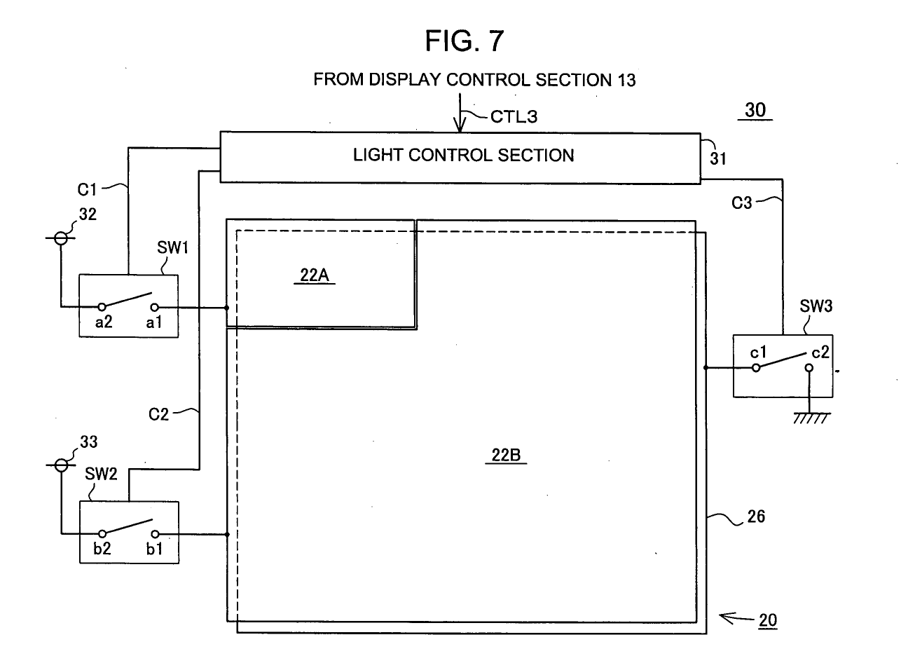

FIGS. 6 and 7 now illustrate a modification to the embodiment shown in FIG. 4. The modification shown in FIGS. 6 and 7 is configured the same as the embodiment shown in FIG. 4, except for the manner of dividing the anode 22. In the example shown in FIG. 4, the anode 22 is divided into two of the upper and the lower, whereas, in an example shown in FIG. 6, the anode 22 is divided into the left and right parts, i.e., into a first electrode piece 22A and a second electrode piece 22B. The example of FIG. 4 illustrates a dividing manner suited to display a lateral text whereas the example of FIG. 6 illustrates a dividing manner suited to display a vertical text. Meanwhile, in the modification shown in FIG. 7, the anode 22 is divided into a first electrode piece 22A in an upper left region and a second electrode piece 22B in a region other than the upper left region.

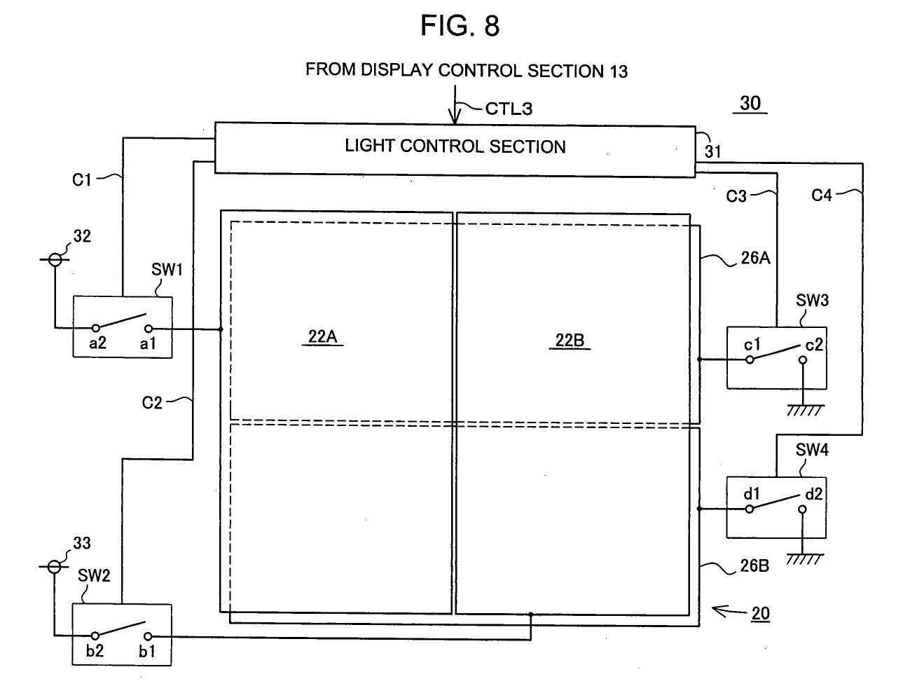

Another example includes a backlight unit 30 shown in FIG. 8. In the backlight unit 30 shown in FIG. 8, the anode 22 is divided into two of a first electrode piece 22A and a second electrode piece 22B and wherein the cathode 26 is also divided into two of a first electrode piece 26A and a second electrode piece 26B.

The light control section 31 individually controls the signals to be supplied respectively to the electrode pieces 22A, 22B, 26A, 26B. Specifically, the electrode pieces 22A, 22B of the anode 22 are respectively connected to one terminals a1, b1 of the switch circuit SW1, SW2. The other terminals a2, b2 of the switch circuits SW1, SW2 are respectively connected to drive power supplies 32, 33. The switch circuits SW1, SW2 are respectively controlled according to the control signals C1, C2 supplied from the light control section 31. Meanwhile, the electrode pieces 26A, 26B of the cathode 26 are respectively connected to one terminals c1, d1 of the switch circuits SW3, SW4. The other terminals c2, d2 of the switch circuits SW3, SW4 are both grounded. The switch circuits SW3, SW4 are respectively controlled according to the control signals C3, C4 supplied from the luminescent control section 31.

According to the backlight unit 30 shown in FIG. 8, consumption power reduction and contrast ratio improvement are possible because of the capability to put off the region of the EL panel 20 corresponding to a display region in black of the display panel 11, and put on a region of the EL panel 20 corresponding to a light display region of the display panel 11.

The embodiment of the present invention is explained in the above. The anode 22 is divided into two parts, no limitation thereto intended in the present invention. The anode 22 may be divided into three parts or more provided such that each electrode piece has at least an area corresponding to a plurality of pixel regions of the display panel 11.

It is understood that the foregoing description and accompanying drawings set forth the preferred embodiments of the invention at the present time. Various modifications, additions and alternatives will, of course, become apparent to those skilled in the art in light of the foregoing teachings without departing from the spirit and scope of the described invention. Thus, it should be appreciated that the invention is not limited to the disclosed embodiments but may be practiced within the full scope of the appended claims.

This application is based on a Japanese Patent Application No. 2003-350424 which is hereby incorporated by reference.

1. A backlight device for illuminating a backside of a display panel having a plurality of display cells arranged in a matrix form, each of the display cells having a light transmissivity varying in response to a drive voltage applied, said backlight device comprising:
a surface luminescent body positioned at a backside of said display panel, and including a surface luminescent layer and first and second electrode layers sandwiching said surface luminescent layer; and
a light control section for supplying a drive signal to said first and second electrode layers to cause said surface luminescent body to emit light;
wherein at least one of said first and second electrode layers is divided into a plurality of electrode pieces, and said light control section supplies the drive signal individually to the plurality of electrode pieces.

2. A backlight device according to claim 1, wherein said luminescent layer is continuously formed.

3. A backlight device according to claim 1, wherein each of said electrode pieces has at least an area corresponding to the plurality of pixel regions of said display panel.

4. A backlight device according to claim 1, wherein said light control section supplies the drive signal only to an electrode piece corresponding to a region other than a display region in black of the plurality of electrode pieces of said display panel.

5. A backlight device according to claim 1, wherein a boundary between said electrode pieces corresponds to a boundary between said display cells.

6. A backlight device according to claim 1, wherein the plurality of electrode pieces are obtained by dividing only one of said first and second electrode layers.

7. A backlight device according to claim 1, wherein said surface luminescent layer includes an electroluminescent material.

8. A backlight device according to claim 1, wherein said display cells include aligned liquid-crystal molecules.

9. A display apparatus comprising:
a display panel having a plurality of display cells arranged in a matrix form, each of the display cells having a light transmissivity varying in response to a drive voltage applied;
a peripheral drive circuit for generating the drive voltage from an image signal supplied to supply the drive voltage to said display cell; and
a backlight device for illuminating a backside of said display panel, said backlight device including:
a surface luminescent body positioned at a backside of said display panel, and having a surface luminescent layer and first and second electrode layers sandwiching said surface luminescent layer; and
a light control section for supplying a drive signal to said first and second electrode layers to cause said surface luminescent body to emit light;
wherein at least one of said first and second electrode layers is divided into a plurality of electrode pieces, and said light control section supplies the drive signal individually to the plurality of electrode pieces.
